(19) United States
(12) Patent Application Publication
(10) Pub. No.: US 2009/0089777 A1
(43) Pub. Date: Apr. 2, 2009

(54) MANAGING SOFTWARE UPDATES IN AN AUTOMATION ENVIRONMENT

(76) Inventors: Bruce Gordon Fuller, Edmonton (CA); Kevin George Gordon, Vancouver (CA); Mark David Hobbs, Hartford, WI (US); Mohamed Salehmohamed, Surrey (CA)

Correspondence Address: ROCKWELL AUTOMATION, INC/SR, 1202 SOUTH SECOND STREET, MAIL STOP E-7F19, MILWAUKEE, WI, 53204, US

(21) Appl. No.: 11/864,949

(22) Filed: Sep. 29, 2007

(51) Int. Cl. G06F 9/445

(52) U.S. Cl. 717/174

(57) ABSTRACT

A scheduling computer receives a plurality of schedules that contain times that a new or different version of a software program will be available, times that one or more machines controlled or monitored by automation computers will be inactive, and times that a necessary resource will be available. The scheduling computer then compares these schedules to determine the time or times when it will be advantageous to install software on the automation computer(s). The scheduling computer then displays these times or time so that software may be installed on the automation computer without disrupting the manufacturing process or inefficiently halting a machine performing a manufacturing step or so that software may be installed on more than one automation computer at substantially the same time.

### TECHNICAL FIELD

The field of the invention relates to automation environments, and in particular, to managing software updates in an automation environment.

### TECHNICAL BACKGROUND

Industrial plants with automated systems often have numerous machines that perform various tasks. These machines may be controlled and/or monitored by computerized controllers and/or data loggers. A single computer may monitor or control a single machine. Alternatively, a single computer may control or monitor multiple machines. When monitoring or controlling a machine, these computers may exchange status and control data with a central information system. Thus, the central information system can track or control the status of individual machines, or control and track many machines at the plant level.

An operator may use a specialized computer called an operator interface terminal to control or monitor an individual machine. The operator provides control inputs to the operator interface terminal, and the operator interface terminal processes the control inputs to transfer a corresponding control signal to the machine. The machine operates in response to the control signal. The operator interface terminal may also receive status data from the machine and may transmit that data to a central server.

In a large automation environment (e.g. a plant or factory), there may be tens, hundreds, or even thousands of operator interface terminals, central information systems, or other automation computers. Collectively, and for the sake of brevity, these will be referred to herein as automation computers.

These automation computers run software installed on them which instructs them in the various tasks involved with controlling and monitoring their respective machines. Examples of such software are RS-View™, RSlogix™, and Factory Talk™ developed by Rockwell Automation.

From time to time, some or all of these automation computers may need one or more software updates or installations. These software installations may be developed by an external software provider, such as Rockwell Automation, or may be internally developed software or configuration changes.

Unfortunately, these software installations may require that the automation computer, or the machine it is associated with, be shut down or otherwise inactivated to perform the installation. This may result in a total or partial shutdown of production in the automation environment. To compound the problem, modern automation environment efficiency may dictate that at least a portion of the automation environment is always in operation. In other words, it may not be economically efficient to shut down the entire plant or a manufacturing line or process to perform software installations on the automation computers. Also, there may not be enough or any IT personnel, 3^{rd} party provider or service personnel, or other critical resources available to install software on the automation computers in a plant or on a manufacturing line during a scheduled shutdown period.

### SUMMARY

In some embodiments of the invention, a scheduling computer receives a first schedule that contains a time that a new or different version of a software program will be available. The scheduling computer also receives a second schedule that contains at least one time period that the machine controlled or monitored by the automation computer will be inactive. The scheduling computer also receives a third schedule that contains at least one time period that a necessary resource (such as, but not limited to, certain personnel) will be available to perform a software installation on the automation computer. The scheduling computer then compares the three schedules to determine the time or times when the necessary resource is available, the new or different version of the software is available, and the machine controlled or monitored by the automation computer is inactive. The scheduling computer then displays these times or time so that software may be installed on the automation computer without disrupting the manufacturing process or inefficiently halting a machine performing a manufacturing step.

In some embodiments of the invention, a scheduling computer also compares the inactivity schedule of at least one more machine being controlled or monitored by a different automation computer. In this case, the scheduling computer displays by using different indicia (such as, but not limited to, color) the times or time when each automation computer may advantageously receive a software installation and when multiple computers may receive a software installation at substantially the same time.

### BRIEF DESCRIPTION OF THE DRAWINGS

FIG. 1 illustrates a software provider and an automation environment.

FIG. 2 illustrates steps of an embodiment of the invention.

FIG. 3 illustrates an automation computer.

FIG. 4 is a timeline illustrating an exemplary schedule for software version availability.

FIG. 5 is an illustration of an exemplary schedule for a machine.

FIG. 6 is an illustration of an exemplary resource schedule.

FIG. 7 is a flowchart illustrating the steps of an embodiment of the invention.

FIG. 8 illustrates a display of a time period where a version of software on an automation computer may advantageously be installed.

FIG. 9 is an illustration of an exemplary schedule for a second machine.

FIG. 10 is a flowchart illustrating the steps of an embodiment of the invention.

FIG. 11 illustrates a display of a time period where versions of software on a plurality of automation computers may advantageously be installed.

### DETAILED DESCRIPTION

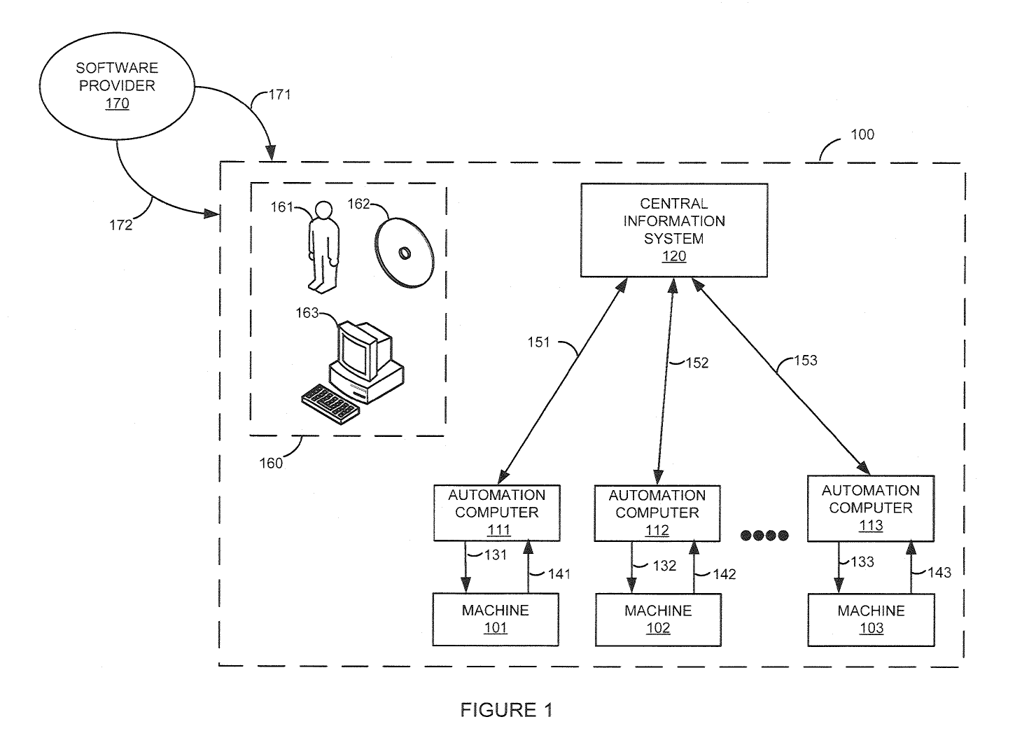

FIG. 1 illustrates a software provider 170 and an automation environment 100. Software provider 170 provides software installations or updates 171 and software version schedules 172 to the automation environment 100. Automation environment 100 comprises machines 101-103, automation computers 111-113, and central information system 120. Typically there are additional machines and automation computers than the number shown. Machines 101-103 may be controlled, monitored, or both, by automation computers 111-113, respectively. Machines 101-103 may produce machine data 141-143 over time. A few examples of machines are pumps and motors, although any type of machine that can be controlled or produces data may be present.

Automation computers 111-113 store and execute software installed on them which instructs them in the various tasks involved with controlling and monitoring their respective machines 101-103. Examples of such software are RS-View™, RSlogix™, and Factory Talk™ developed by Rockwell Automation. Other monitoring or controlling software may also be stored and executed on automation computers 111-113.

Automation environment 100 also includes necessary resources 160. Examples of such necessary resources are IT or 3^{rd} party provider or service personnel 161, or a master distribution disc 162 or other memory device, or another machine (e.g. a substitute for an inactive machine on the production line) or computer 163 necessary to perform a software installation on a particular automation computer. Computer 163 may also be networked to automation computers 111-113 and capable of distributing or installing software 171 automatically or according to a schedule determined by an embodiment of the invention.

Automation computers 111-113 may comprise human-machine interfaces that allow human operators to control machines 101-103. An example of an automation computer is the PanelView™ product line from Rockwell Automation. Other automation computers are possible. Automation computers 111-113 receive control inputs from their human operators and transfer corresponding control signals 131-133 to machines 101-103, respectively. For example, a human operator may input an instruction to automation computer 111 to increase the speed of machine 101. In response, automation computer 111 would transfer a control signal 131 to machine 101 that causes machine 101 to increase its speed. Because automation computer 111 and machine 101 transfer control signals or data between them, machine 101 is said to be associated with automation computer 111.

Automation computers 111-113 also receive data signals 141-143 from respective machines 101-103. Data signals 141-143 may indicate the status of respective machines 101-103. For example, data signals 141-143 could indicate the speeds of respective machines 101-103 every 5 seconds. Automation computers 111-113 may also record the data from data signals 141-143.

Automation computers 111-113 may display this data to their human operators. For example, automation computer 111 may receive data signal 141 indicating the current speed of machine 101. In response, terminal 111 would display that current speed along with other data it knows or has collected.

Periodically, automation computers 111-113 may transfer data 151-153 to another automation computer known as a central information system 120. Data 151-153 may indicate the data that was recorded by automation computers 111-113 based on data signals 141-143. Thus, data 151-153 may indicate the data produced by machines 101-103. Data 151-153 may also indicate other information contained in or known by automation computers 111-113 such as, but not limited to, the operational status (e.g. on or off, active or inactive, fast or slow) of machines 101-103, respectively, or the operational schedule of machines 101-103. Central information system 120 may record the machine data for all machines 101-103.

For example, every ten minutes, automation computer 111 may transfer data to central information system 120 indicating the speed of machine 101 at five second intervals for the past ten minutes. Automation computers 112-113 may do the same for machines 102-103. Central information system 120 may then record this data and may generate a single graph comparing the speeds of machines 101-103 over the last ten minutes. Central information system 120 could run enterprise historian software, such as the RSBizWare™ Historian™ software from Rockwell Automation, to collect and record the data. Other enterprise historian software is possible.

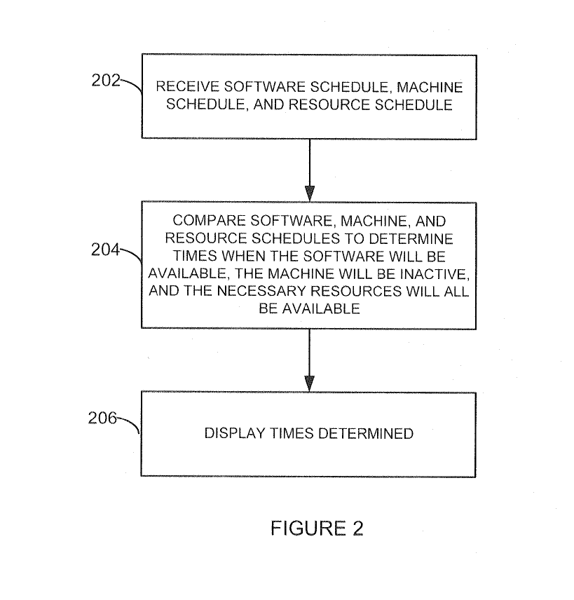

FIG. 2 illustrates steps of an embodiment of the invention. These steps may be performed by automation computers 111-113, central information system 120, or some other computer 163 such as a conventional personal computer (PC) or workstation. The computer that performs these steps is referred to as the scheduling computer. In a step 202, a software schedule, a machine schedule, and a resource schedule are received. A software schedule may include information detailing when new software, or when new versions of software currently installed in the automation environment will be available to the automation environment. The machine schedule may include information detailing when a particular machine, or machines, will be inactive. The resource schedule may contain information detailing when certain resources necessary to install software will be available.

In a step 204, the software, machine, and resource schedules are compared to determine times when the software will be available to install, a machine or machines will be inactive, and certain resources necessary to install the software will all be available. In a step 206, the time or times when the software will be available to install, a machine or machines will be inactive, and certain resources necessary to install the software will all be available are displayed. In an alternative embodiment, the software would be installed on an automation computer or computers associated with the inactive machine or machines according to when the software will be available to install, a machine or machines will be inactive, and certain resources necessary to install the software will all be available. This software installation may be performed automatically using a necessary resource such as computer 163 or central information system 120 or any other computer that is networked to automation computers 111, 112, or 113. Alternatively, the software installation may also be performed manually using necessary resources such as master distribution disc 162 or personnel 161.

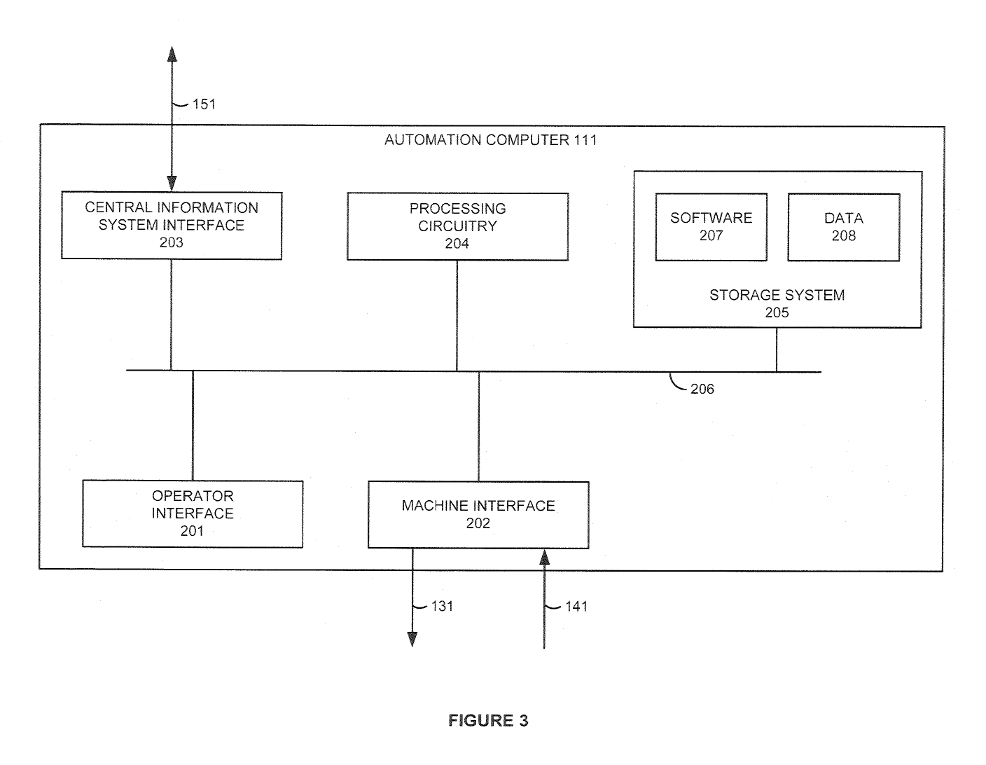

FIG. 3 illustrates automation computer 111. Automation computer 111 comprises operator interface 201, machine interface 202, central information system interface 203, processing circuitry 204, storage system 205, and communication circuitry 206. Storage system 205 stores software 207 and data 208. Communication circuitry 206 exchanges communications between interfaces 201-203, processing circuitry 204, and storage system 205. Automation computers 112-113 and 120 are configured in a similar way and operate in a similar manner.

Operator interface 201 receives inputs from a human operator and transfers corresponding user instructions to processing circuitry 204. Operator interface 201 receives display information from processing circuitry 204 and displays the information to the human operator. Operator interface 201 may comprise a touch screen, keypad, display, speaker, microphone, control buttons, joystick, control switches, or some other user interface. Operator interface 201 may be a single device or be distributed among multiple devices.

Machine interface 202 receives control information from processing circuitry 204 and transfers a corresponding control signal 131 to machine 101. Machine interface 202 receives data signal 141 from machine 101 and transfers corresponding data to processing circuitry 204. Machine interface 202 may exchange signals 131 and 141 with machine 101 over wireless, metallic, optical, or some other data transmission media. Machine interface 202 may comprise a transceiver, port, antenna, circuitry, or some other communication components. Machine interface 202 may use Ethernet, Internet Protocol, Wireless Fidelity, or some other communication protocol. Machine interface 202 may be a single device or be distributed among multiple devices.

In the case of automation computers 111-112, central information system interface 203 may receive or send data 208 from processing circuitry 204 and may exchange data 151 with central information system 120. Central information system interface 203 may exchange data 151 with central information system 120 over wireless, metallic, optical, or some other data transmission media. Central information system interface 203 comprises a transceiver, port, antenna, circuitry, or some other communication components. Central information system interface 203 may use Ethernet, Internet Protocol, Wireless Fidelity, or some other communication protocol. Central information system interface 203 may be a single device or be distributed among multiple devices.

In the case of automation computer 120, the central information system interface 203 may receive or send data 208 from processing circuitry 204 and may exchange data 151 with the other automation computers 111-113. Central information system interface 203 may exchange data 151 with automation computers 111-113 over wireless, metallic, optical, or some other data transmission media. Central information system interface 203 comprises a transceiver, port, antenna, circuitry, or some other communication components. Central information system interface 203 may use Ethernet, Internet Protocol, Wireless Fidelity, or some other communication protocol. Central information system interface 203 may be a single device or be distributed among multiple devices.

Processing circuitry 204 receives user instructions from operator interface 201. Processing circuitry 204 processes the user instructions to transfer corresponding control information to machine interface 202. Processing circuitry 204 receives data from machine interface 202. Processing circuitry 204 may correlate the data to time and date to form data 208 and transfer data 208 to storage system 205. Processing circuitry may also process data 208 to generate display information indicating, for example, the data plotted against time. Processing circuitry may also transfer the display information to operator interface 201. Periodically, processing circuitry may retrieve data 208 from storage system 205 and transfer data 208 to central information system interface 203. Processing circuitry may receive data 208 from central information system interface 203 and transfer data 208 or software 207 to storage system 205.

Processing circuitry 204 retrieves and executes software 207 from storage system 205. Software 207 may comprise an operating system, utilities, drivers, networking software, application programs, firmware, or some other form of machine-readable processing instructions. When executed by processing circuitry 204, software 207 directs processing circuitry 204 to operate as described herein. Processing circuitry 204 may comprise a microprocessor, logic circuitry, computer, or some other processing device. Processing circuitry 204 may be distributed among multiple devices.

Storage system 205 may comprise a memory device, such as a disk, flash memory circuitry, or some other machine-readable memory apparatus. Storage system 205 may be distributed among multiple devices. Portions of storage system 205 may contain software configured to cause automation computer 111 to perform steps of an embodiment of the invention. Likewise, portions of software 207 may be configured with steps of an embodiment of the invention. Portions of storage system 205 may be external to automation computer 111 in some embodiments. For example, a memory device that is external to automation computer 111 may store application software that is subsequently transferred into automation computer 111 to form a portion of software 207.

From time to time, new or different versions of software 207 may become available. This new software or different version may contain increased or improved functionality, new configurations, bug fixes, or may be less expensive to license or use. When new software or a different version of software 207 becomes available from the producer of such software 207, it may be desirable to install that new or different version on one or more of automation computers 111-113, 120. However, because, for example, automation computer 111 may be actively controlling or monitoring machine 101, and installing software 207 may cause or require that automation computer 111 interrupt its controlling or monitoring of at least one machine 101, and such interruption may cause undesirable effects such as data loss, equipment malfunction, or a safety hazard, installing software 207 as soon as a new or different version of software 207 is available may be undesirable. In addition, the resources necessary to install software 207 may also not be available at the same time the new software or different version is first available so that installing software 207 immediately after the new software or different version is available may be impossible.

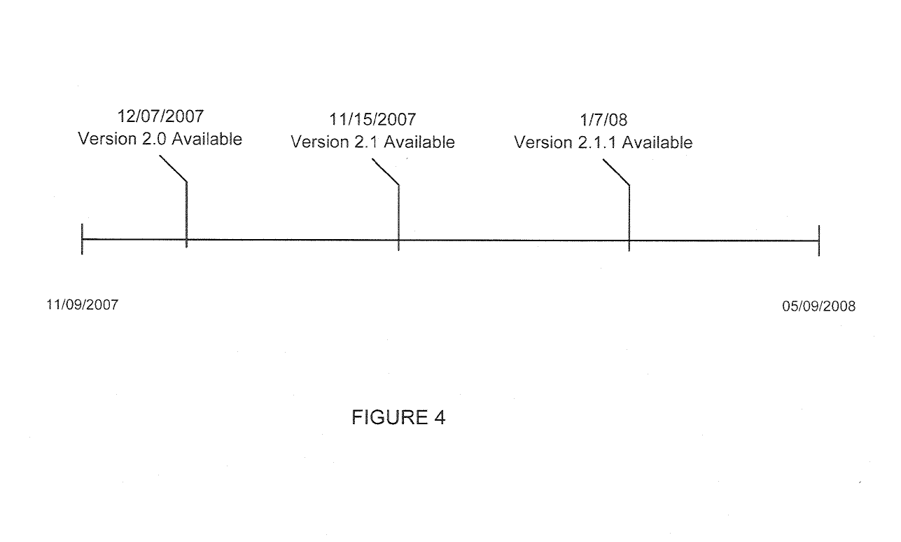

FIG. 4 is a timeline illustrating an exemplary schedule for software availability. FIG. 4 shows a timeline from Aug. 29, 2007 to Feb. 27, 2008. Also indicated on FIG. 4 are the dates that versions 2.0, 2.1 and 2.1.1 of an exemplary software program 207 will be available. Version 2.0, 2.1 and 2.1.1 are shown on FIG. 4 as becoming available on Sep. 26, Nov. 15, and Jan. 7, 2008, respectively.

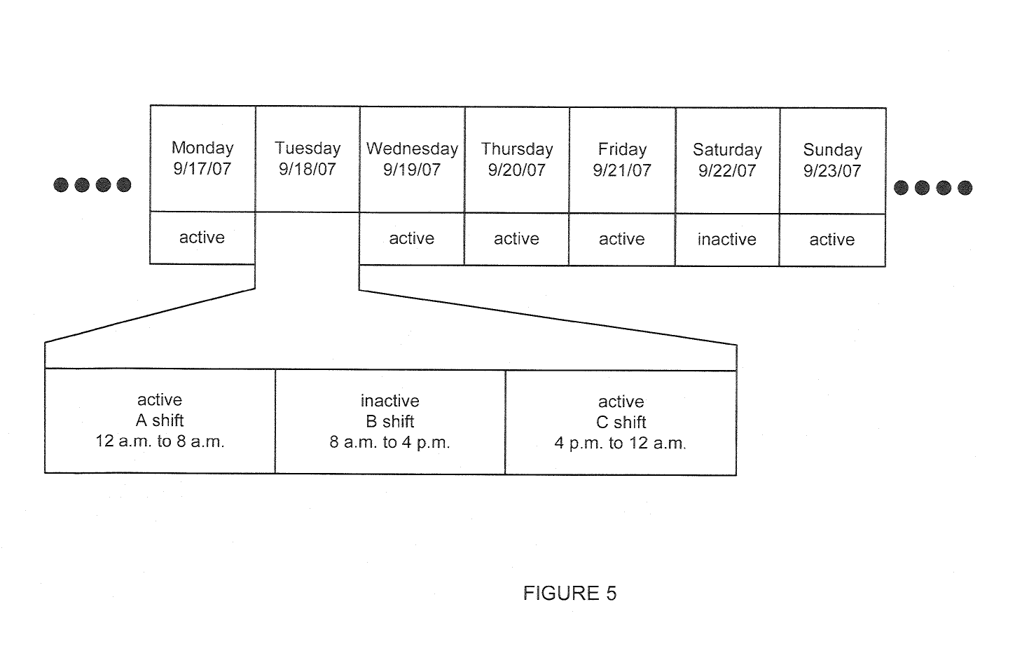

FIG. 5 is an illustration of an exemplary active/inactive schedule for a first machine. The exemplary active/inactive schedule shown in FIG. 5 could, for example, be the active/inactive schedule for machine 101. The exemplary week is shown in FIG. 5 as being from Monday, Sep. 17, 2007, to Sunday, Sep. 23, 2007. FIG. 5 shows that the machine will be active all of Monday, Wednesday, Thursday, Friday, and Sunday. FIG. 5 also shows that the machine will be active on Tuesday during the A and C shifts which are 12 a.m. to 8 a.m. and 4 p.m. to 12 a.m., respectively. FIG. 5 also shows that the machine will be inactive all day Saturday and also on Tuesday during the B shift which is 8 a.m. to 4 p.m.

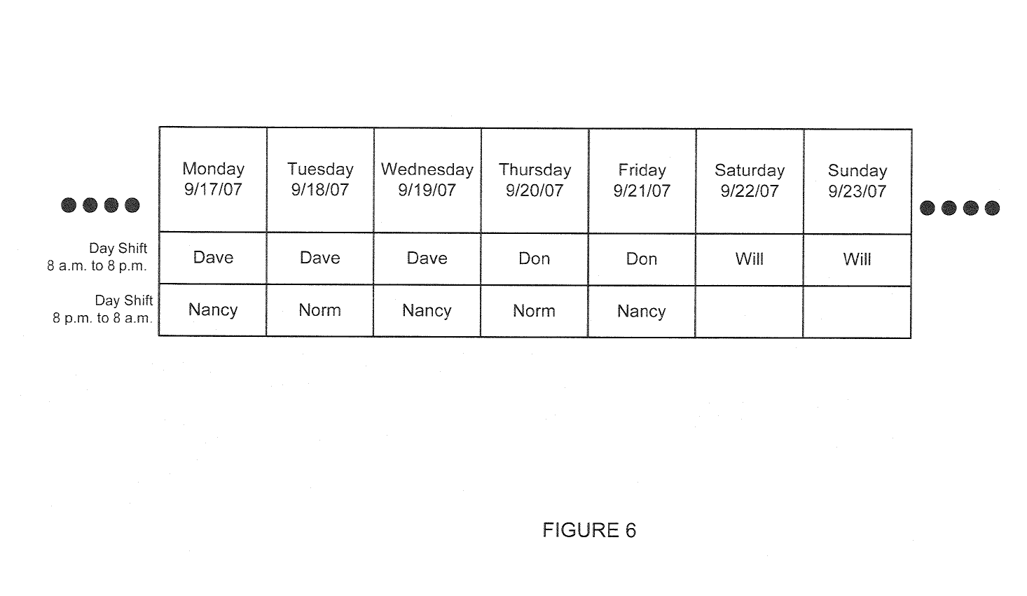

FIG. 6 is an illustration of an exemplary necessary resource schedule. In this case, the exemplary resource is IT personnel. However, the necessary resource could be anything necessary to perform software version changes, or inactivate a machine, such as a certain device, or a certain copy of the media upon which the new or different software is stored.

In the case of FIG. 6, for exemplary purposes only, the necessary resource schedule shown is a work schedule for a set of IT employees that are capable of installing new or different software for the week of Sep. 17 to Sep. 23, 2007. FIG. 6 shows that Dave will be working the day shift (8 a.m. to 8 p.m.) on Monday, Tuesday, and Wednesday. FIG. 6 also shows that Don will be working the day shift on Thursday and Friday and Will is working the day shift Saturday and Sunday. Nancy is working the night shift (8 p.m. to 8 a.m. the next day) on Monday, Wednesday, and Friday. Norm is working the night shift on Tuesday and Thursday. The night shift on Saturday and Sunday is not staffed.

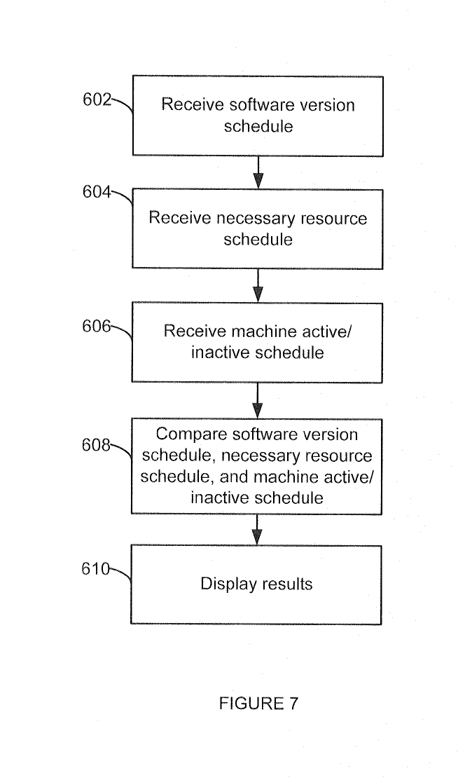

FIG. 7 is a flowchart illustrating the steps of an embodiment of the invention. These steps may be performed by automation computers 111-113, central information system 120, or some other computer such as a conventional personal computer (PC) or workstation. The computer that performs these steps is referred to as the scheduling computer. In a step 602, a software version schedule is received. An exemplary illustration of a software version schedule is shown in FIG. 4. However, FIG. 4 is only exemplary and the exact content, form, or data structure of the software version schedule is arbitrary and may be easily chosen by one skilled in the art. In a step 604, a necessary resource schedule is received. An exemplary illustration of a necessary resource schedule is shown in FIG. 6. However, FIG. 6 is only exemplary and the exact content, form, or data structure of the necessary resource schedule is arbitrary and may be easily chosen by one skilled in the art. In a step 606, a machine active/inactive schedule is received. An exemplary illustration of a machine active/inactive schedule is shown in FIG. 5. However, FIG. 5 is only exemplary and the exact content, form, or data structure of the necessary resource schedule is arbitrary and may be easily chosen by one skilled in the art. In a step 608, the software version schedule, necessary resource schedule, and the machine active/inactive schedule are compared to find at least one time when a new or different version of the software is available, a necessary resource is available, and the machine associated with the automation computer is inactive.

To illustrate step 608 by way of example, consider the schedules shown in FIGS. 4, 5, and 6. Consider FIG. 4 and assume that prior to Sep. 17, 2007, automation computer is running version 1.0 of a particular software product and that there are no new versions available. Accordingly, because prior to Sep. 17, 2007, there is not a new or different version of the software product, no new or different version can be installed and the result of the comparison in step 608 for the time period prior to Sep. 17, 2007, is that there is no time where a new or different version of that software product may be advantageously installed. FIG. 4 also shows that on Sep. 17, 2007, a new version of the software product will become available (version 2.0). Accordingly, the comparison in step 608 examines the necessary resource schedule exemplified by FIG. 6 for the time period from (and including) Sep. 17, 2007, and later. As shown in FIG. 6, there is no staffing capable of installing new or different software on the night shift on Saturday and Sunday, September 22^{nd} and 23^{rd}. Therefore, these times are less desirable for advantageously installing the new software version. The comparison in step 608 also examines the machine active/inactive schedule exemplified by FIG. 5. The machine active/inactive schedule of FIG. 5 shows that the machine will be inactive all day Saturday the 22^{nd}, Sunday the 23^{rd}, and during the B shift on Tuesday the 18^{th}. Accordingly, the results of the comparison in step 608 would indicate that the advantageous times to install the new version of the software are during the B shift on Tuesday the 18^{th}, and during the day shift on Saturday and Sunday the 22^{nd} and 23^{rd}.

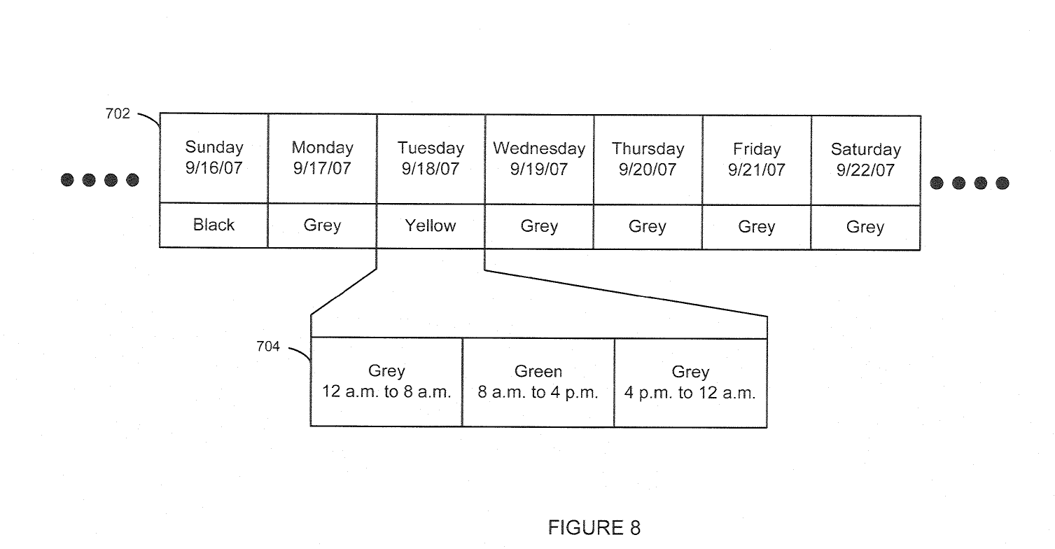

In a step 610, the results of the comparison produced in step 608 are displayed. FIG. 8 illustrates a display of a time period where a version of software on an automation computer may advantageously be changed in an embodiment of the invention. In FIG. 8, the week of September 16^{th} to September 22^{nd} is shown 702. During that week, Sunday, September 16^{th} is shown in black. This indicates to the user that no new version of the software is available. Monday, Wednesday, Thursday, Friday, and Saturday are shown in grey. This indicates to the user that a new version of the software is available, but either the machine will be active, or a necessary resource will not be available. Accordingly, to install the new version of the software during the times shown in grey, some extraordinary action would need to be taken such as changing the work schedule, or halting production to inactivating the machine during a time when it was not scheduled to be inactive.

In FIG. 8, Tuesday, September 18^{th} is shown in yellow. This indicates to the user that there is at least some time period during that day whereby new software may be advantageously installed because a new version is available, all the necessary resources such as IT personnel are available, and the machine associated with the automation computer receiving the new software will be inactive. FIG. 8 also shows a detail display for Tuesday 704. The detail display for Tuesday 704 shows which times during Tuesday the software may be advantageously installed. As can be seen from the detailed display for Tuesday, the times of 12 a.m. to 8 a.m. and from 4 p.m. to 12 a.m. are shown in grey because either the machine will be active, or a necessary resource will not be available. However, the time from 8 a.m. to 4 p.m. is shown in green because during that time period the new software may be advantageously installed because a new version is available, all the necessary resources, such as IT personnel are available, and the machine associated with the automation computer receiving the new software will be inactive.

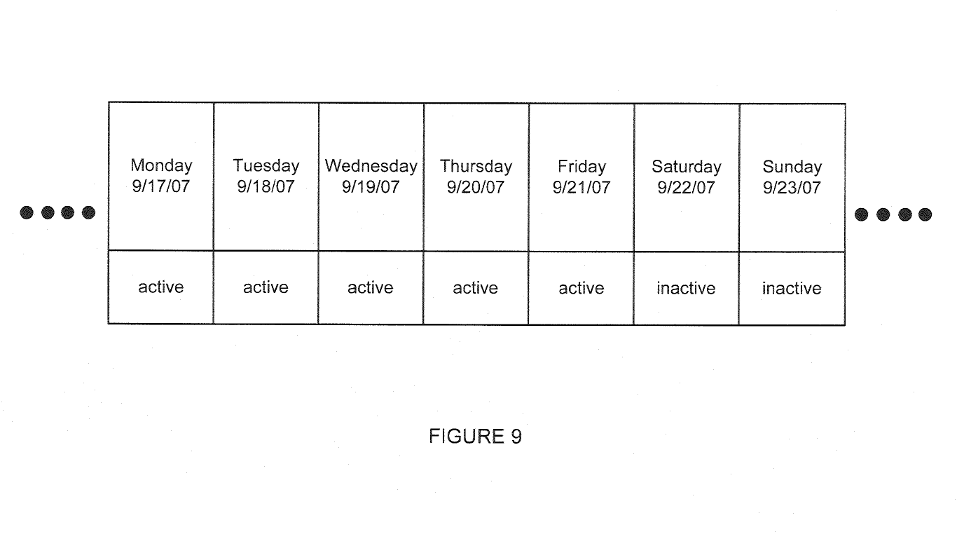

FIG. 9 is an illustration of an exemplary active/inactive schedule for a second machine. The exemplary active/inactive schedule shown in FIG. 9 could, for example, be the schedule for machine 102. The exemplary week is shown in FIG. 9 as being from Monday, Sep. 17, 2007, to Sunday, Sep. 23, 2007. FIG. 9 shows that the second machine will be active all of Monday, Tuesday, Wednesday, Thursday, and Friday. FIG. 9 also shows that the second machine will be inactive all day Saturday and Sunday.

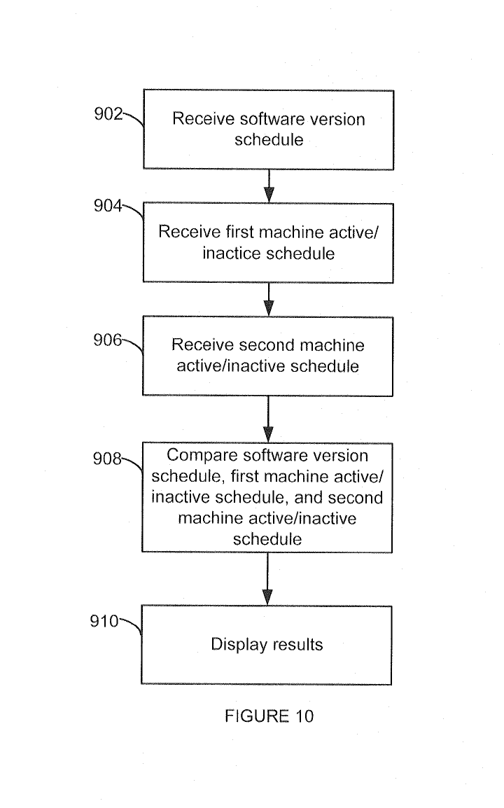

FIG. 10 is a flowchart illustrating the steps of an embodiment of the invention. These steps may be performed by automation computers 111-113, central information system 120, or some other computer such as a conventional personal computer (PC) or workstation. The computer that performs these steps is referred to as the scheduling computer. In a step 902, a software version schedule is received. An exemplary illustration of a software version schedule is shown in FIG. 4. However, FIG. 4 is only exemplary and the exact content, form, or data structure of the software version schedule is arbitrary and may be easily chosen by one skilled in the art. In a step 904, a first machine active/inactive schedule is received. An exemplary illustration of a first machine active/inactive schedule is shown in FIG. 5. However, FIG. 5 is only exemplary and the exact content, form, or data structure of the first machine active/inactive schedule is arbitrary and may be easily chosen by one skilled in the art.

In a step 906, a second machine active/inactive schedule is received. An exemplary illustration of a machine active/inactive schedule is shown in FIG. 9. However, FIG. 9 is only exemplary and the exact content, form, or data structure of the second machine active/inactive schedule is arbitrary and may be easily chosen by one skilled in the art.

In a step 908, the software version schedule, first machine active/inactive schedule, and the second machine active/inactive schedule are compared to find at least one time when a new or different version of the software is available, the machine associated with a first automation computer is inactive, and the machine associated with a second automation computer is inactive. In an alternative embodiment, the software version schedule, first machine active/inactive schedule, the second machine active/inactive schedule, and a necessary resource schedule are compared to find at least one time when a new or different version of the software is available, the machine associated with a first automation computer is inactive, the machine associated with a second automation computer is inactive, and a necessary resource is available.

To illustrate step 908 by way of example, consider the schedules shown in FIGS. 4, 5, and 9. Consider FIG. 4 and assume that prior to Sep. 17, 2007, automation computer is running version 1.0 of a particular software product and that there are no new versions available. Accordingly, because prior to Sep. 17, 2007 there is not a new or different version of the software product, no new or different version can be installed and the result of the comparison in step 908 for the time period prior to Sep. 17, 2007, is that there is no time where a new or different version of that software product may be advantageously installed. FIG. 4 also shows that on Sep. 17, 2007, a new version of the software product will become available (version 2.0). Accordingly, the comparison in step 908 examines the first machine active/inactive schedule exemplified by FIG. 5 for the time period from (and including) Sep. 17, 2007, and later. As shown in FIG. 5, the first machine will be active Monday, Tuesday during the A and C shifts, Wednesday through Friday, and Sunday. Therefore, these times are less desirable for advantageously installing the new software version.

The comparison in step 908 also examines the second machine active/inactive schedule exemplified by FIG. 9. The machine active/inactive schedule of FIG. 9 shows that the second machine will be inactive all day Saturday the 22^{nd} and Sunday the 23^{rd}. Accordingly, the results of the comparison in step 908 would indicate that an advantageous time to install the new version of the software on both the first and second automation computers is all day Saturday the 22^{nd}.

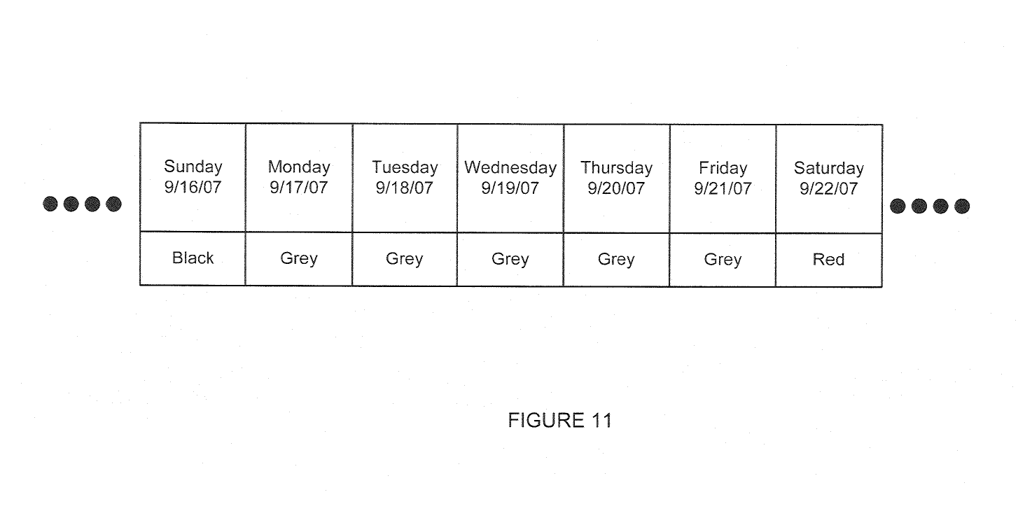

In a step 910, the results of the comparison produced in step 908 are displayed. FIG. 11 illustrates a display of a time period where a version of software on an automation computer may advantageously be installed on a plurality of automation computers in an embodiment of the invention. In FIG. 11, the week of September 16^{th} to September 22^{nd} is shown. During that week, Sunday, September 16^{th} is shown in black. This indicates to the user that no new version of the software is available. Monday, Tuesday, Wednesday, Thursday, and Friday are shown in grey. This indicates to the user that a new version of the software is available, but either the first machine or second machine will be active. Accordingly, to install the new version of the software during the times shown in grey, some extraordinary action would need to be taken such as inactivating a machine during a time when it was not scheduled to be inactive.

In FIG. 11, Saturday, September 22^{nd} is shown in red. This indicates to the user that there is at least some time period during that day whereby software may be advantageously installed because a new or different version is available, and a plurality of machines associated with a plurality of automation computers receiving the new software will be inactive.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of managing software installation in an automation environment having a first computer that is running a first version of a software program, and said first computer is associated with a first machine, comprising:
receiving a software schedule that contains a time that a second version of said software program will be available;
receiving a first machine schedule that contains at least one time period that said first machine will be inactive;
receiving a resource schedule that contains at least one time period that a necessary resource will be available;
comparing said software schedule, said first machine schedule, and said resource schedule to determine at least one time period that the second version of said software program will be available, said first machine will be inactive, and said necessary resource will be available; and,
displaying said at least one time period that the second version of said software program will be available, said first machine will be inactive, and said necessary resource will be available.

2. The method of claim 1 wherein said step of displaying uses different indicia to indicate said at least one time period and other times.

3. The method of claim 2 wherein said different indicia is different colors.

4. The method of claim 1 wherein said an automation environment further comprises a second computer that is running said first version of said software program, and said second computer is associated with a second machine, further comprising:
receiving a second machine schedule that contains at least one time period that said second machine will be inactive;
comparing said software schedule and said first machine schedule and said second machine schedule and said resource schedule to display a schedule that shows by different display indicia when said second version of said software program may be installed on said first computer, when said second version of said software program may be installed on said second computer, and when said second version of said software program may be installed on both said first computer and said second computer at substantially the same time.

5. The method of claim 4 wherein said different indicia is different colors.

6. The method of claim 5 wherein said step of displaying includes a detail display that shows said at least one time period.

7. A program storage device readable by a machine, tangibly embodying a program of instructions executable by the machine to perform method steps for managing software installation in an automation environment having a first computer that is running a first version of a software program, and said first computer is associated with a first machine, said method steps comprising:
receiving a software schedule that contains a time that a second version of said software program will be available;
receiving a first machine schedule that contains at least one time period that said first machine will be inactive;
receiving a resource schedule that contains at least one time period that a necessary resource will be available;
comparing said software schedule, said first machine schedule, and said resource schedule to determine at least one time period that the second version of said software program will be available, said first machine will be inactive, and said necessary resource will be available; and,
displaying said at least one time period that the second version of said software program will be available, said first machine will be inactive, and said necessary resource will be available.

8. The method of claim 7 wherein said step of displaying uses different indicia to indicate said at least one time period and other times.

9. The method of claim 8 wherein said different indicia is different colors.

10. The method of claim 7 wherein said an automation environment further comprises a second computer that is running said first version of said software program, and said second computer is associated with a second machine, further comprising:
receiving a second machine schedule that contains at least one time period that said second machine will be inactive;
comparing said software schedule and said first machine schedule and said second machine schedule and said resource schedule to display a schedule that shows by different display indicia when said second version of said software program may be installed on said first computer, when said second version of said software program may be installed on said second computer, and when said second version of said software program may be installed on both said first computer and said second computer at substantially the same time.

11. The method of claim 10 wherein said different indicia is different colors.

12. The method of claim 11 wherein said step of displaying includes a detail display that shows said at least one time period.

13. A system for managing software installation in an automation environment having a first computer that is running a first version of a software program, and said first computer is associated with a first machine, comprising:
a memory that contains a software schedule that contains a time that a second version of said software program will be available and a first machine schedule that contains at least one time period that said first machine will be inactive and a resource schedule that contains at least one time period that a necessary resource will be available;
comparing circuitry configured to compare said software schedule, said first machine schedule, and said resource schedule to determine at least one time period that the second version of said software program will be available, said first machine will be inactive, and said necessary resource will be available; and,
a display showing said at least one time period that the second version of said software program will be available, said first machine will be inactive, and said necessary resource will be available.

14. The system of claim 13 wherein said display shows different indicia to indicate said at least one time period and other times.

15. The system of claim 14 wherein said different indicia is different colors.

16. The system of claim 13 wherein said an automation environment further comprises a second computer that is running said first version of said software program, and said second computer is associated with a second machine, further comprising:
said memory containing a second machine schedule that contains at least one time period that said second machine will be inactive;
and wherein said comparing circuitry is configured to compare said software schedule and said first machine schedule and said second machine schedule and said resource schedule;
and wherein said display shows a schedule that shows by different display indicia when said second version of said software program may be installed on said first computer, when said second version of said software program may be installed on said second computer, and when said second version of said software program may be installed on both said first computer and said second computer at substantially the same time.

17. The system of claim 16 wherein said different indicia is different colors.

18. The system of claim 17 wherein said step of displaying includes a detail display that shows said at least one time period.
